(19) United States
(12) Patent Application Publication
(10) Pub. No.: US 2014/0246139 A1
(43) Pub. Date: Sep. 4, 2014

(54) PRINT FINISHING METHOD AND CORRESPONDING DEVICE

(71) Applicant: Peter Barth, Celle (DE)

(72) Inventor: Peter Barth, Celle (DE)

(73) Assignee: Qualcomm Incorporated, San Diego, CA (US)

(21) Appl. No.: 14/349,726

(22) PCT Filed: Oct. 4, 2012
(86) PCT No.: PCT/DE2012/100308

§ 371 Date: Apr. 4, 2014

(30) Foreign Application Priority Data
Oct. 6, 2011 (DE) 10 2011 054 221.3

(51) Int. Cl. B41F 23/08; B41F 21/00; B41F 19/00

(52) U.S. Cl. CPC B41F 23/08; B41F 19/001; B41F 19/005; B41F 21/00
USPC 156/64; 156/390; 156/378

(57) ABSTRACT

A print finishing method, including feeding sheet-type printing products, laminating, coating and foil-stamping, with the steps being carried out in treatment modules and the printing product (D) to be finished being first detected and aligned in every treatment module. Also, a print finishing machine for sheet-type printing products (D), with a sheet-conveying system (11); a laminating device for laminating the printing product (D) with a laminating film; a coating device for coating the printing product (D) with a coat, and a foil-stamping device for transferring a transfer layer which adheres to a carrier film onto the printing product (D) in places intended to be imprinted. The laminating device (2), the coating device (3) and the foil-stamping device (4) each contain at least one section of the conveying system (11) and the sections of the conveying system are suction feedboards (21, 31, 41).

The invention relates to a print finishing process for sheet-type print products D with modular handling of laminating, coating and foil stamping.

Furthermore, the invention relates to a print finishing machine for sheet-type printing products D with a conveyor for the print product D, a laminating device for laminating the print product D with a laminating film, a coating device for coating the print product D with a coating and a foil stamping device for transferring a transfer layer adhered to a carrier foil onto the intended print locations of the print product D.

A print finishing machine of this type is known from DE 10 2009 020 753 A1. This print finishing machine has a sheet conveyor system in a base machine with at least one interface along the sheet conveying path with coupling structures for releasably coupling a replaceable finishing processing module. At this printing finishing machine, a base machine having a plurality of operational coupling points can be provided, wherein there may be coupled to these provided coupling points a foil stamping module, a coating module, a relief imprinting module, a cutting module and a print module, etc. Thus, it is certainly possible to configure a print finishing machine so that a desired print processing product is produced therewith; however, the reconfiguration involving a crane device is time-consuming and dangerous, and further due to the roller transfer of the supplied print products a high-precision alignment of the respective processing modules coupled on the basic machine is required. Consequently, it is impossible to retrofit this print finishing machine for small and very small print runs (single copies to several 100 copies) at competitive prices.

However, as printed products are increasingly presented through digital media and accordingly touchable printing products experienced a significant reduction in circulation, at the same time these printed products are, however, more individual, more flexible and more complex; there is a great need to produce individually finished printed products at low cost and in very limited editions. It is therefore important, even with the pressure relief arrangements, to focus exclusively on digital printing process and to largely avoid machine reconfiguration and/or to design it technically simple.

Further, from DE 100 47 394 A1 a modular printing machine system, in which a first printing machine can be coupled with a different second printing machine. The modular printing machine system processes sheet-type printed products, which are transferred on a sheet delivery means from a sheet feeder to a transport device of the second printing press, where they are issued after the print finishing at the sheet delivery means. Also with this printing machine system is a conversion possible only with considerable time, labor and expense. A shift from job to job is illusory. Rather, the modular system is intended to keep the manufacturer's production costs low.

Furthermore, DE 692 07 751 T2 discloses a cold-foil stamping process based on the offset printing principle in which a printing plate is always required for the indirect transfer of the adhesive. There is shown a combination of pressure machine modules, with which various steps can be performed, for example providing a gold plating on a sheet form print product. A conversion of the entire machine by changing the order of the printing press modules is also not possible at reasonable cost due to the size and the adjustment of the machines.

JP 61141555 A shows only a coating device (coater), in a printing method for sheet form printed products.

EP 0264347 A2 discloses a printing process for endless paper webs, wherein the paper web is detected and aligned.

Beginning with DE 10 2009 020 753 A1, therefore, the invention is based on the object of providing a print finishing process and a device therefore, with which a print finishing can be produced economically and as quickly as possible even at the low number print runs and even individual prints.

This object is achieved with a print finishing method according to claim 1 and a print finishing device according to claim 5.

The recognition and orientation of the print product undergoing finishing at each processing module ensures that the transition from one module to the next module does not require high-precision alignment, but only a safe transition of the printed product from one module to the next module within a certain amount of dimensional tolerance. Thus, the coupling elements of the modules may be designed to be much simpler and therefore faster to operate. Accordingly, a conversion of the order of the modules in such a print finishing process is substantially faster and is economically feasible. Preferably, the detection and orientation occurs on a suction belt associated with each processing module.

Because the processing modules can be exchanged in their sequence via standardized transfer interfaces, the processing steps of lamination, coating and foil stamping can be performed in any order.

To avoid having to reconfigure the module sequence for individual print products or for very short runs of a few tens, and/or to perform a processing operation such as a second foil stamping, individual print products (D) are taken from a module and supplied to an upstream module.

With respect to the device, the characterizing feature of the print finishing machine according to the invention lies in that the modular separation of laminating, coating and foil stamping device is designed so that for each module there is assigned a section of the conveyor for the print product in the form of a suction belt. The suction belt serving as conveyor can also be designed to comprise multiple units within a module, to the extent that this is required due to presence of processing roller pairs, alignment devices or the like. In a preferred embodiment the laminating, the coating and the foil stamping devices, in their conveyor sections, are formed as modules with standardized transfer interfaces, wherein each conveyor section upstream of the respective print finishing process has sensors and aligners for determining the position and orientation of the printed product D and the transfer interfaces have mechanical and electrical centering- and coupling-elements.

Accordingly, the three main common print finishing processes are united modularly in a print finishing machine. Accordingly, these three processing methods can be performed in one operation one-after-the-other and, if necessary, the order of processing may also be changed. Due to the provision of print product sensors and aligners on the respective suction band of each print finishing step, a high position accuracy and repeatable positioning for the individual printing finishing process will be achieved.

Preferably, the print product sensors and aligners 22, 32, 42 have, on the sides, side stops adjustable to the sheet size, and sheet front and rear edge sensors, or other sheet alignment methods known from the graphic arts industry. With the sheet leading- and trailing-edge sensors the length of the sheet format (printed product), and thus the precise positioning in the operating direction, is determined. The side stops, which can be set automatically or manually adjusted to the width of the sheet format, in contrast, provide the exact orientation of the print product stream laterally to the working direction.

If the standardized transfer interfaces 5 have a first coupling element with prominent journals on one side of each module and a second coupling element with matching journal receiving sockets on the other side of the modules, then a quick coupling and decoupling for module transitions can be realized. For example, if the modules are movable on wheels, the modules can be moved to the floor of the production hall in the desired order and are connected by the pin or journal-coupling elements. The journals, optionally with centering means, thereby allow a sufficiently accurate alignment of the mutually coupled modules.

If at the end and the beginning of the suction belt 21, 31, 41 a vacuum-free area of 1 cm to 5 cm is provided, a clean transfer of the printed product to the next module or to the stacker is made possible because the adhesion of the printed product is avoided at the belt direction change.

Since a manipulation option is provided for return of individual sheets of printed products D, which makes it possible to take a printed product D, after a pass through a module, to an upstream module, it is possible to process individual printed products in a different order than the currently established sequence of three print processing modules, or to take the returned product back through the print finishing process a second time.

In the following an embodiment of the invention will be described in greater detail with reference to the accompanying drawings.

There is shown in:

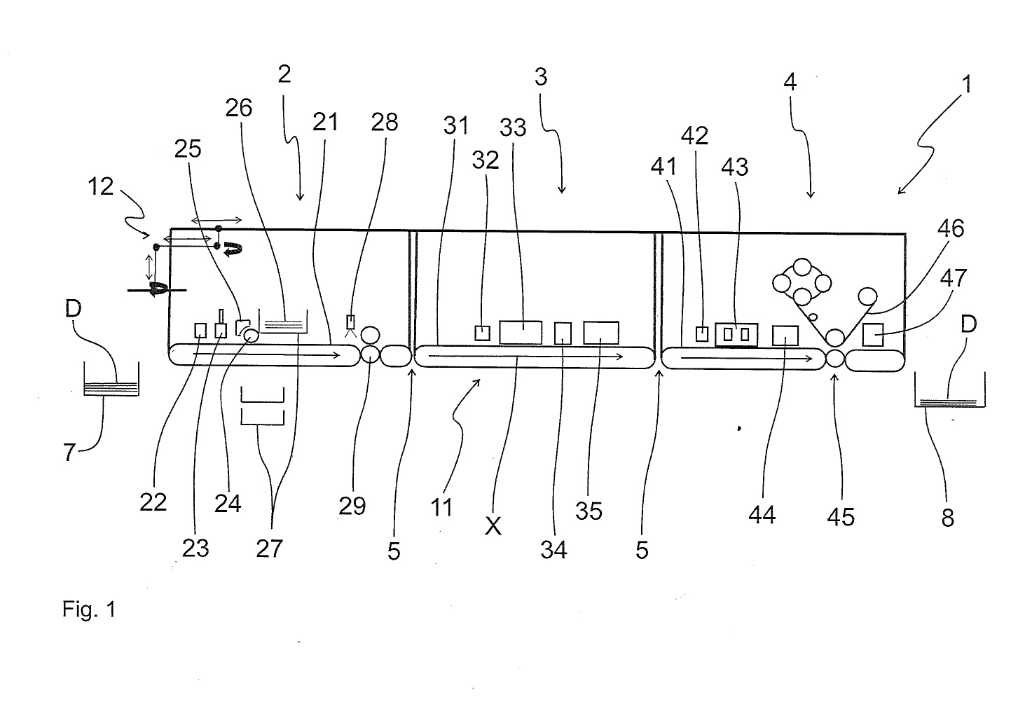

FIG. 1 a print finishing machine according to the invention in a schematic diagram.

In FIG. 1, a print finishing machine 1 is shown in a schematic diagram. The features described below are, where appropriate, discussed in the working direction indicated in FIG. 1 by the arrow X.

The print finishing machine 1 consists of three modules, namely, a laminating device 2, a coating device 3 and a foil stamping device 4. The devices 2, 3, 4 are of modular construction and can be reversed in order. In the illustrated embodiment, the modules are coupled as described above each other in the working direction X. Upstream of the first module, in this embodiment the laminating device 2, is located a feeder 7. Downstream of the last module, here the foil stamping device 4, is arranged a stacker 8. A sheet-type print product D is stored in feeder 7. In stacker 8 the finished printed product D is stored. Between feeder 7 and stacker and 8, a s conveyor 11 is provided, which leads straight through the three modules as an integral part thereof. The conveyor 11 is implemented in the form of a suction belt.

The conveyor 11 associated with laminating device 2 has a two-part first suction band 21. Here, downstream of the feeder 7 on the first suction band 21 is located a first print product sensor and product aligner 22, for example in the form of a sheet leading edge and/or sheet trailing edge sensor with sheet alignment. Downstream from the pressure sensor and product aligner 22, an adhesive applicator 23 is provided, which applies a short trail of glue or adhesive droplets on the print product D.

Downstream of the adhesive applicator 23, a feed means 24 is provided for laminating film above the first suction belt 21, which has a transfer cylinder, which is not described in greater detail, which forwards a laminating film 26 trimmed to a particular format around 180° on the peripheral surface of the transfer cylinder as a function of the signal given by the print product sensor and aligner 23 precisely to the print product conveyed on the first suction band 21. Here, the formatted laminating film 26, which is coated with a thermally reactive adhesive, runs past an infrared heating device 25 and is heated without contact, whereby the adhesive is activated.

The formatted laminating films 26 are, dependent on their respective format, stored in individual stacks in film magazines 27, wherein the film magazines can be changed 27 program-controlled by the control unit of print finishing machine 1. Thus, a particular respective formatted laminating film 26 can be placed on the respective print product D present on the first suction band 21.

Downstream of the feed means 24 is arranged a smoothing means 28 in the form of air nozzles directed onto the laminated foil and a subsequently pressing means 29 consisting of a pair of rollers. The first suction band 21 is interrupted at the pair of rollers 29, whereupon the processed printed product D is fed from the first part to the gap of the pair of rollers 29 and transferred from there to the second part of the first suction belt 21.

The coater 3 attaches itself downstream of the laminating device 2 via a transfer interface 5 with centering and coupling elements. The coater 3 has a second suction band 31 as downstream conveyor 11, on which the printed product D is further conveyed in the direction of X. First, the print product D comes to a second print product sensor and aligner 32 at which the print product D is detected and aligned. Downstream of the second print product sensor and aligner or aligner 32 a coating print head 33 is arranged, for example, containing two transversal guided ink printing heads with which two different coating agents, such as gloss or matt paint or structure/relief paint can be applied to the print product (D). The paint print heads 33 are guided transversely to the direction X above the second suction band 31 according to the digital data, and are positioned to the side over a closed container after each printing or production break. In this “parked position” excess liquid coating is removed from the bottom of the print heads and a rinse is carried out by rinsing with acetone and/or lacquer.

Downstream of the paint print head 33 is provided an optional processing assist 34 and subsequently a UV curing device 35. Curing of the applied coating takes place in the UV curing device 35 via a UV light source, in particular a LED UV light or a high intensity UV light source.

The painted print product D is then transferred via another transfer interface 5 from the second suction band 31 to a third suction band 41 of the subsequent foil stamping device 4. Downstream of the transfer interface 5 is located a third print product sensor and aligner 42 on the third suction band 41, which detects the print product D and aligns it on the third suction band 41. Downstream from the print product sensor and aligner 42, an adhesive application means 43 is provided, which is equipped for example with two print heads. The first print head can apply a thin liquid adhesive on the printed product D in the prescribed locations for planar or flat places. The second print head 43 provides a build-up adhesive in the locations intended for pseudo embossing on the printed product D.

Downstream from the adhesive application means 43, an adhesive activating means 44 is provided, which can emit, depending on the adhesive used therein, for example, a UV radiation to the adhesive-coated printed product D, after which the adhesive applied on the printed product D still maintains a sufficiently adhesive surface.

Downstream from the adhesive activation means 44, a sheet or foil transfer means 45 is arranged, the film or foil transfer means 45 including a transfer roller and opposite thereto a counter-pressure or platen roller, which form a pair of calender rollers. The gap which forms between the rollers lies at the transport height of the third suction belt 41, which is interrupted in the region of the roller pair.

A transfer foil 46 is fed around the transfer roller of the foil transfer means 45, which goes from a foil supply roller about the transfer roller to foil take-up roller. On the take-up roller the carrier foil is wound with the unused transfer layer.

The transfer roller is designed so it can be lifted off the form of the platen roller, so that a synchronous transport of the transfer foil 46 along with the transport of the printed product D in the direction of X only needs to be made when a transfer of the transfer layer adhered on the transfer foil 46 onto the print product D is to occur. When transfer is not to occur, the transfer roller is removed from the platen and the transport of the transfer foil 46 is stopped. In the next required foil printing then the transfer roller is moved together with the platen roller while the transfer foil 46 is driven in synchrony to the third suction band 41. The timing is done using the signal determined with the third print product sensor and aligners 42 in conjunction with the proposed locations for the foil stamping.

In order to perform with this foil stamping device 4 both flat or planar foil printing well as a pseudo embossing transfer, the roller of the foil transfer means 45 is preferably formed with an elastic covering of low strength, which allows a uniform pressure to be applied even in places with arched raised points of the pseudo embossing with the built-up adhesive. The elastic wrap conforms just around the pseudo embossing and, due to the elastic yielding, a crushing or smearing of just applied pseudo embossing is avoided. Furthermore, it is thus possible to apply also on the pseudo embossing a transfer layer (foil printing) which is pressed by the elastic pressure from the elastic-coated transfer roller completely all over the pseudo embossing under uniform pressure.

Downstream of the sheet transfer means 45, a curing device 47 is arranged, which causes a complete curing of the adhesive applied on the product D.

Then the finished printed product D is delivered to the stacker 8 or transferred to a subsequent further machine

Further, in FIG. 1, a manipulation means 12 is shown, which can be guided along the working direction X of the print processing machine 1, for example, on a monorail or an arm in the form of a manipulating robot. The manipulation means 12 has a gripper, which can grip a sheet form print product D at appropriate sites, namely, at the end of each module, and can return it counter to the working direction X to the start of the module or a module in front of it. Thereby the individual print products can be processed in other than the presently set up module order, or can be passed twice through a print finishing process.

Both the feeder 7 as well as the stacker 8 are also formed, each with a transfer point 5, so that they can be coupled as separate modules to any of the three print finishing modules 2, 3, 4 arranged in any order. Alternatively, a hand-feeding system could be carried out.

The print finishing steps realized in the individual processing modules do not require any printing plate but occur as a direct coating on the print sheet. So there are no printing plates, nor coating plates, nor embossing cylinder or special stamping tools required for the raised embossing. Consequently, a print product can be produced without first requiring tool production and tool change-out in the print finishing machine.

Therewith there can, with the print finishing machine or the print finishing process described here, be created quickly and inexpensively even in very small numbers from 1 to 200, a production of high quality finished printed products.

### LIST OF REFERENCE NUMERALS

1 print finishing machine
11 conveyor means, sheet conveyor system
12 manipulation means
2 laminating means, first module
21 first suction band
22 first print product sensor and aligner
23 adhesive applicator
24 feed means
25 infrared heater
26 formatted laminating film
27 film magazine
28 smoothing means
29 pressing means, roller pair
3 coater, second module
31 second suction band
32 second print product sensor and aligner
33 coating or paint printhead
34 processing assist
35 UV-curing device
4 foil stamping device, third module
41 third suction band
42 third print product sensor and aligner
43 adhesive application means
44 adhesive activator
45 foil transfer agent
46 transfer foil
47 curing device
5 transfer Interface
7 feeder
8 stacker
D print product
X direction of work

1.-10. (canceled)

11. A print finishing process comprising the steps
supplying sheet-type print products,
laminating the sheet-type print products (D) in a laminating module,
coating the sheet-type print products (D) in a coating module, and
foil stamping the sheet-type print products (D) in a foil stamping module, wherein the steps of laminating, coating and foil stamping are carried out in any order, and
wherein the print product (D) to be finished is first detected and aligned at each processing module.

12. The print finishing method according to claim 11, wherein the detection and alignment occurs on a suction belt associated with each processing module.

13. The print finishing method according to claim 11, wherein interchanging of the processing modules in their order occurs via standardized transfer interfaces.

14. The print finishing method according to claim 11, wherein individual print products (D) are taken from one of said modules and fed to an upstream module.

15. A print finishing machine for a sheet-shaped print product (D) comprising:
a sheet conveyor system (11) for conveying the sheet-type print product (D);
a laminating device for laminating the print product (D) with a laminating film;
a coater for coating the print product (D) with a coating, and
a foil stamping device for transferring a transfer layer adhered on a carrier foil onto the locations of a print product (D) intended to be printed,
wherein
the laminating device (2), the coating device (3) and the foil stamping device (4) each include at least a portion of the conveying means (11),
the laminating device (2), the coating device (3) and the foil stamping device (4), with their portions of the conveying means (11), are formed as modules with standardized transfer interfaces (5),
the sections of the conveying means are suction belts (21, 31, 41),
each conveying section (21, 31, 41) upstream of the respective print processing has print product sensors and aligners (22, 32, 42) for determining the position and orientation of the print product (D), and
the transfer interfaces (5) have mechanical and electrical centering and coupling elements.

16. The print finishing machine according to claim 15, wherein the print product sensors and aligners (22, 32, 42) have lateral side stops adjustable to the sheet size and sheet front and rear edge sensors.

17. The print finishing machine according to claim 15, wherein the standardized transfer interfaces (5) have a first coupling element with a projecting journal on one side of each module and a second coupling element with mating journal receptacle on the other side of the module.

18. The print finishing machine according to claim 15, wherein a vacuum-free area of 1 cm to 5 cm is provided at the end and the beginning of the suction belt (21, 31, 41).

19. The print finishing machine according to claim 15, wherein a manipulation means (12) is provided for return of individual print products (D), which can return a print product (D) after passing through a module back to an upstream module.
